(19) United States
(12) Patent Application Publication
(10) Pub. No.: US 2003/0126192 A1
(43) Pub. Date: Jul. 3, 2003

(54) Protocol processing

(76) Inventor: Andreas Magnussen, Fredensborg (DK)

Correspondence Address: FISH & RICHARDSON, PC, 4350 LA JOLLA VILLAGE DRIVE, SUITE 500, SAN DIEGO, CA, 92122, US

(21) Appl. No.: 10/034,526

(22) Filed: Dec. 27, 2001

(51) Int. Cl. G06F 15/16

(52) U.S. Cl. 709/202

(57) ABSTRACT

A system includes a first agent, a processing agent for processing a protocol, and a second agent. The second agent is connected to the first agent to receive and transmit events, and the processing agent has connections with the first agent, the connections transporting data between the first agent and the second agent and the processing agent transporting events to the first agent when the data being transmitted has been modified. The first agent is configured to monitor the data being transmitted to and received from the processing agent.

### FIELD OF THE INVENTION

This invention relates to protocol processing.

### BACKGROUND

In many communication protocols, such as Transmission Control Protocol/Internet Protocol (TCP/IP), User Datagram Protocol (UDP), (Internetwork Packet Exchange) IPX, Secure Sockets Layer (SSL), Server Load Balancing (SLB), and Extended Markup Language (XML), data is sent from a source to a destination in the form of packets that pass along a transmission path established by the protocol. Flow control schemes can be provided to share the network resources among active transmission paths or connections.

### DESCRIPTION OF DRAWINGS

FIG. 1 is a block diagram of a TCP processing system.

FIG. 2 is a block diagram of TCP agents of FIG. 1.

FIG. 3 is a flowchart for the TCP system of FIG. 1.

### DETAILED DESCRIPTION

In general, in one aspect of the invention, a system includes a first agent, a processing agent for processing a protocol, and a second agent. The second agent is connected to the first agent to receive and transmit events, and the processing agent has connections with the first agent, the connections transporting data between the first agent and the second agent and the processing agent transporting events to the first agent when the data being transmitted has been modified. The first agent is configured to monitor the data being transmitted to and received from the processing agent.

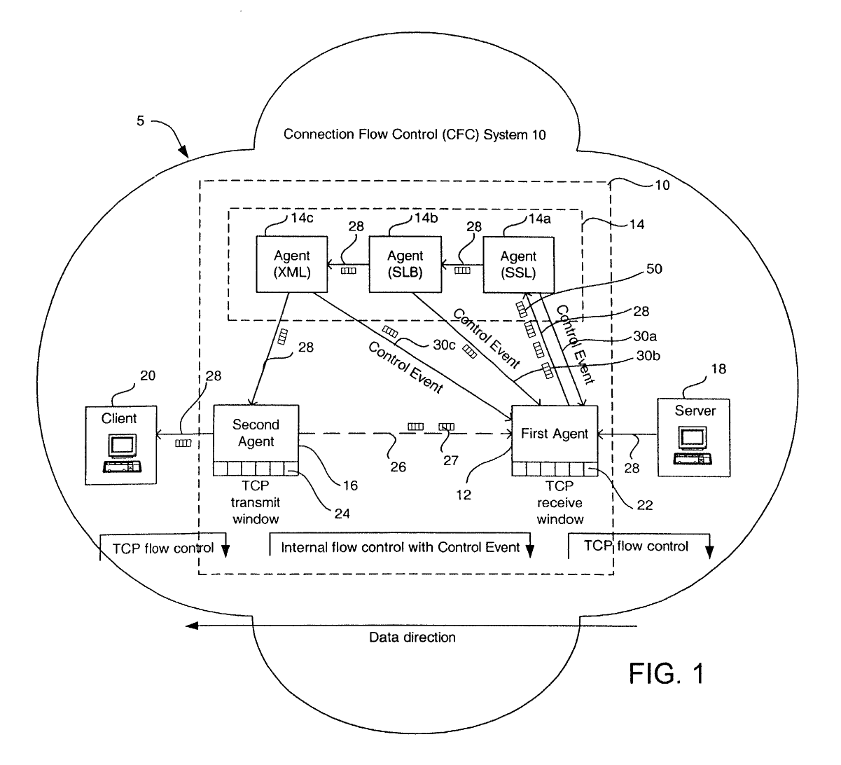

Referring to FIG. 1, a connection flow control (CFC) system 10 includes two TCP agents 12 and 14 and three processing agents 14, i.e., processing agents 14a-14c. TCP agents 12 and 14 are processing entities in communication with a client 20 and a server 18 in a computer network system 5, respectively. Agents 12 and 14 implement the full TCP stack.

Processing agents 14 are used to provide different functionalities from which network operators may choose. Each of the processing agents 14 includes a general central processing unit (CPU) system implementing a particular protocol function, with associated management and control features. For example, Secure Sockets Layer (SSL) protocol processing agent 14a is implemented to provide secure communications over the computer network system 5, and particularly, over the Internet. Server Load Balancing (SLB) protocol processing agent 14b is utilized to distribute date efficiently across different network server systems. Extended Markup Language (XML) protocol processing agent 14c is used to assist in processing data in the XML data format.

Processing agents 14 provide higher protocol level functionality, usually at protocol layers above TCP, for example, and are connected to the computer network system 5 to provide the higher-level functionality (Open Systems Interconnect (OSI) Level 5 (Session layer) and higher). Processing agents 14 are implemented in hardware, such as with an application-specific integrated circuit (ASIC), or in software. Communications and transmission of data among processing agents 14a-14c are implemented in hardware as well. Each processing agent 14a-14c is adapted to transmit and retrieve data packets 50 to and from the first agent 12 so that each processing agent 14a-14c has complete control over what data it will receive and transmit.

CFC system 10 provides a data transmission channel 28 through which all data packets 50 are transmitted from first agent 12, through processing agents 14, to second agent 16 and client 20. CFC system 10 provides control channels 30a-30c for transporting control messages from each of the processing agents 14a-14c back to first agent 12. Control channels 30a-30c provide the control plane, through which ownership of data packets 50, for example, is moved between processing agents 14 and through which events or control messages are exchanged.

Events are preferably of constant size, but should be flexible so that new types of control events may be developed as required. Events are not limited to that of passing ownership of payload data, but may be event notifications such as the notification of a timer expiration or a connection setup, for example.

Generally, an event is a notification that a change is occurring that affects processing agents 14 receiving the event. For example, events may notify a transfer of ownership of a data (e.g., TCP) payload from processing agent 14a to another processing agent 14b. Events are the main mechanism for communication between processing agents 14 and are utilized for all inter-processing agent communication that requires an action from the receiving agent, e.g., first agent 12. When an event is a simple event, such as passing ownership of a TCP payload, there would typically not be any control headers or fields in the data chunks, i.e., the essential data that is being carried within data packets 50, excluding any “overhead” data required to get data packets 50 to its destination. For some of the more advanced events, such as a request to open a new connection, there may be a control header or field in the data chunk.

CFC system 10 provides a control channel 26 between first agent 12 and second agent 16 for passing control information 27 from second agent 16 to first agent 12. Control information 27 includes a feedback mechanism such as an acknowledgment field in a data packet so the sender, i.e., first agent 12, can be made aware that the receiver, i.e., second agent 16, has received data packets 50. The control information 27 can also include various types of information to throttle first agent 12 into transmitting no faster than second agent 16 can handle the arrival of traffic of data packets 50.

First agent 12 includes a TCP transmit window 22 and second agent 16 provides a corresponding TCP receive window 24. Flow control mechanisms such as Stop-And-Wait protocols implement an algorithm for flow control where a “sliding window” is used. The “window” is the maximum amount of data packets 50 which can be sent without having to wait for ACKs, i.e., control information 27 via the control channel 26. In particular, the operation of the algorithm is to first transmit all new data packets in the window, wait for control information 27 to arrive (several data packets 50 can be acknowledged in the same control information 27), and then “slide” the window to an indicated position and re-set the window size to the value included in control information 27.

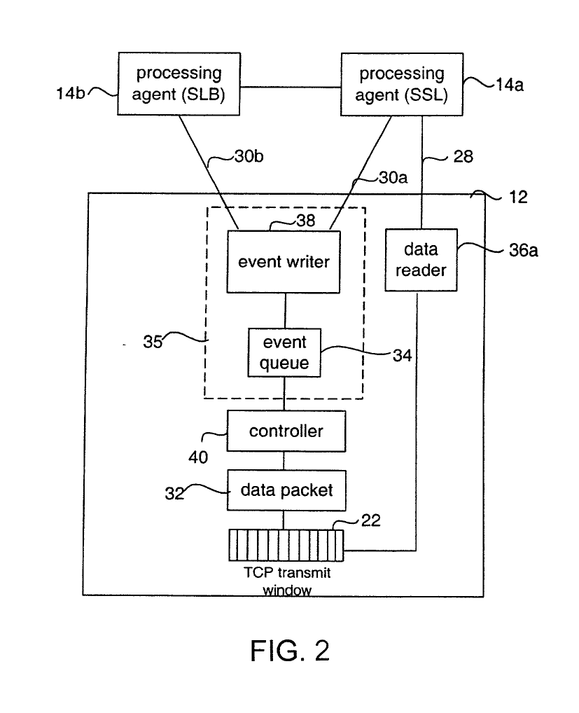

Referring to FIG. 2, first agent 12 includes a controller 40, which provides data channel 28 for data packets 50 implemented through an event queue system 35 (described below). Data channel 28 and control channels 30a-30b are separated. Controller 40 provides a general storage of data with pointer semantics (i.e., requiring a handle or pointer to retrieve data therefrom). Data packet 32 is preferably stored in controller 40 in data chunks, which is up to 2 KB each. Controller 40 may support larger data chunks which may be utilized for communication between processing agents 14. However, using smaller data chunks avoids complexity in processing agents 14.

A controller handle (not shown) is used to identify a data chunk stored in controller 40. Therefore, when one of processing agents 14 has written a data chunk to controller 40, a handle or token is returned to processing agent 14a, for example. In other words, the handle is like a key to access a particular data chunk stored in the controller 40. When processing agent 14a desires to retrieve the data chunk, processing agent 14a generates a read command to controller 40 with the handle as a parameter. However, there is no requirement that each data packet or frame on the network interface map onto a single data chunk.

First agent 12 includes event queue system 35 which is integrated with first agent 12. Events are sent and received by event queue system 35, with events being delivered by control channels 30a-30b to event queue system 35. Event queue system 35 includes an event writer 38 and an event queue 34. When processing agents 14 transmit an event to first agent 12, it is preferably directed to event queue writer 38. Event queue writer 38 further directs events to event queue 34. Although only event queue 34 is shown, two or more event queues can be associated with each processing agent 14a-14b. Events within event queue 34 cycle through queues so that the events are processed according to the order in which they are received and/or by priority.

In a sense, a queue of pending events for processing agents 14 may be viewed as a queue of pending tasks. When the processing agent 14 has completed a task and is ready for new processing, it retrieves an event from its event queue 34 and performs any processing required by that event.

In certain embodiments, the size of an event is approximately 16 bytes, and some fields in the event may be predefined, while the remainder may be utilized by firmware for its own requirements. However, any suitable configuration of an event, including its size, may be utilized. The event may include an event type identification field (e.g., one byte long) to identify the type of the event. This field preferably exists in all events in order to distinguish the different event types. Some examples of event type identification include: timer timeout, new connection setup, or connection payload. The event may also include a TCP data pointer field to point to the TCP connection the event involves. A handle field may be included with the event to refer to the data chunk stored in controller 40 to which it corresponds. An adjustUnitSize field is provided in an event to indicate the length and size of the data chunk, e.g., in bytes. A prefetch field may be included in an event to determine whether the data chunk, or part of it, should be prefetched by hardware before a processor processes the event.

A flow control mechanism such as a “sliding window” for avoiding queue overruns to prevent loss of events is implemented by TCP transmit window 22, preferably per connection. A data reader 37 reads data packets to be processed from TCP transmit window 22 and forwards data packets 50 to processing agents 14.

The operation of CFC system 10 will now be described with reference to FIGS. 1-3.

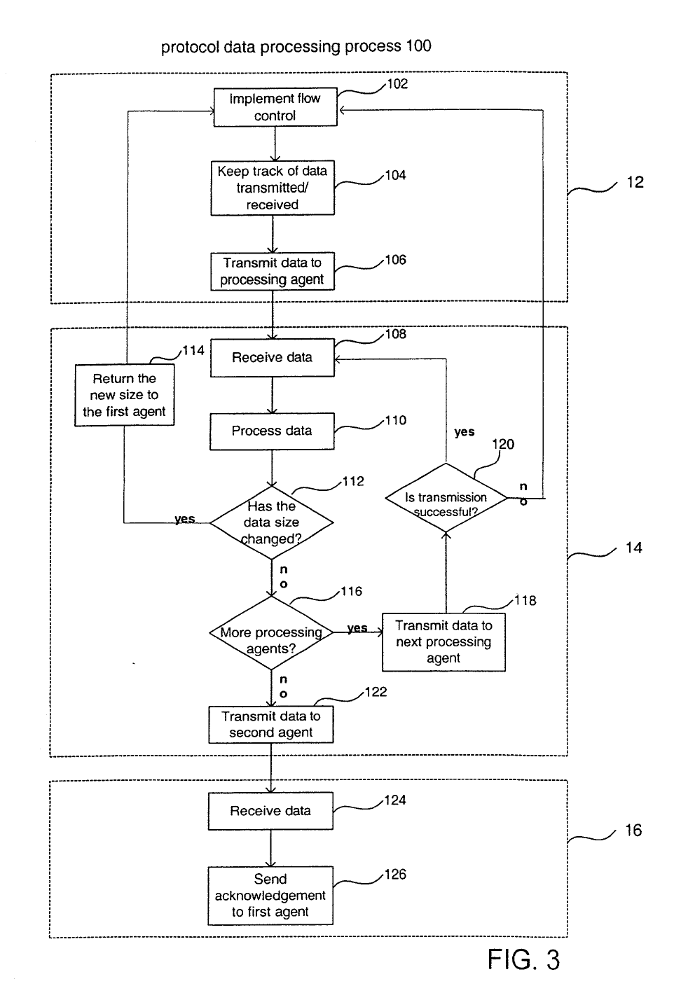

Referring to FIG. 3, a high-speed protocol data processing process 100 of the CFC system 10 is illustrated. TCP data packets 50, for example, are transferred through controller 40 (FIG. 2). As mentioned above, the processing agents 14 manage the information in the OSI Level 5 (Session Layer) and higher.

Protocol data processing process 100 transfers information between first agent 12 and second agent 16 via processing agents 14. After data packets 50 have been stored in the first agent, more particularly, in controller 40, protocol data processing process 100 begins by transmitting data packets 50 from first agent 12 to second agent 16. First agent 12 implements flow control mechanisms (102) such as sliding window protocols described above which can appropriately manage and control traffic of data flow through the data channel 28. First agent 12 keeps track of data packets being received and transmitted (104) from first agent 12 to processing agents 14. Data packet fields such as unitSize transmitted and unitSize returned from other processing agents 14 back to first agent 12 are monitored. After implementing flow control implementation and monitoring of packet data fields, first agent 12 transmits data packets 50 to processing agents 14 (106).

When processing agents 14 receive data packets 50 (108) from first agent 12, processing agents 14 process the data (110) included in data packets 50. During processing of the data, certain fields of the data may be modified (112). For example, the size of the data packet 50 may have been changed (114).

If modifications have occurred in the data length or size of data packet 50, then processing agent 14a, e.g., generates a control event 30a (FIG. 1) to be sent to first agent 12 (114), informing first agent 12 of the modification in the data size. Upon receiving this event, first agent 12 places the event on event writer 38 and event queue 34 and performs any processing that is required by the event, such as updating data packet 32 and modifying TCP transmit window 22 accordingly (FIG. 2). First agent 12 again implements any necessary flow control (102), keeps track of data received and transmitted (104) and continues on to transmit data packets 50 to processing agents 14 (106).

If no modifications occur during the processing by processing agents 14, protocol data processing process 100 determines if additional processing agents exist (116). If additional neighboring processing agents 14 are present, data is forwarded on to the next processing agent 14b (118) and if such data transmission is successful (120), data is received (108) and processed (110) as described before. If transmission has been unsuccessful, protocol data processing process 100 passes control to first agent 12 to begin process 100 again.

If no additional neighboring processing agents 14 are present, data packets 50 are transmitted to second agent 16 (124). Second agent 16 receives data (124) and sends control information 27 via control channel 26 (FIG. 1) back to first agent 12 (126). Second agent 16 also adjusts its TCP transmit window 24 prior to sending control information 27 to first agent 12.

Various other processing agents 14 may be utilized to provide additional functionality to the computer network system implementing CFC system 10. Lower-level types of protocols may also be implemented in processing agents 14, such as a TCP termination protocol processing entity for terminating traffic from a server or a client in a network.

Accordingly, the systems and methods described provide a modular system that allows a network operator to easily add new processing agents as required to provide additional network functionality and implement different protocols. Processing agents such as agents 14 with general processor execution standard software may be used with present systems and methods to implement higher-level (TCP and above) protocol processing.

Other embodiments are within the scope of the following claims.

What is claimed is:

1. A system comprising:
a first agent;
a second agent connected to the first agent to receive and transmit events and data;
a processing agent to process a protocol, the processing agent being connected to the first agent,
the processing agent being configured to send events to the first agent upon a change in the data being transmitted.

2. The system of claim 1 wherein the first agent is configured to monitor the data being transmitted to and received from the processing agent.

3. The system of claim 1 further comprising an event system coupled to the processing agent to store the events in the event system.

4. The system of claim 1 wherein the first agent includes an algorithm for flow control for the connections.

5. The system of claim 1 wherein the processing agent comprises a Secure Sockets Layer (SSL) system.

6. The system of claim 1 wherein the processing agent comprises a Server Load Balancing (SLB) system.

7. The system of claim 1 wherein the processing agent comprises an Extended Markup Language (XML) system.

8. The system of claim 1 wherein the events include at least one of an event type identification, a Transmission Control protocol (TCP) pointer, a controller handle, a controller length, and a controller prefetch.

9. The system of claim 1 wherein the data stored in the first agent includes a header and a data portion.

10. The system of claim 1 wherein the event system includes an event queue writer and event queue reader for the processing agent.

11. A method comprising:
transporting data between the first network agent and a second network agent through a processing agent, and
transporting events from a processing agent to the first agent upon a change in the data being transported.

12. The method of claim 11 wherein the first agent monitors data being transmitted to and received from the processing agent.

13. The method of claim 11 further comprising performing flow control of the data sent from the first agent to the second agent.

14. The method of claim 13 further comprising storing the events in an event system coupled to the processing agent.

15. The method of claim 11 wherein the first agent uses an algorithm for flow control for transporting data from the first agent through the processing agent to the second agent.

16. The method of claim 11 wherein the processing agent comprises a Secure Sockets Layer (SSL) System.

17. The method of claim 11 wherein the processing agent comprises a Server Load Balancing (SLB) system.

18. The method of claim 11 wherein the processing agent comprises an Extended Markup Language (XML) system.

19. The method of claim 11 wherein the events include at least one of an event type identification, a Transmission Control protocol (TCP) pointer, a controller handle, a controller length, and a controller prefetch.

20. The method of claim 11 wherein the data stored in the first agent includes a header and a data portion.

21. The method of claim 11 wherein the event system includes an event queue writer and event queue reader for the processing agent.

22. A machine-readable storage medium bearing machine-readable program code capable of causing a machine to:
store data in a first agent;
connect the first agent to a second agent to receive and transmit events;
process a protocol by connecting a processing agent to the first agent, wherein the connections transport data between the first agent and the second agent and the processing agent transports events to the first agent upon a change in the data being transmitted.

23. The system of claim 22 wherein the machine-readable program code further includes instructions to monitor the data being transmitted to and received from the processing agent.

24. The system of claim 22 wherein the processing agent is a Secure Sockets Layer (SSL) system.

25. The system of claim 22 wherein the processing agent is a Server Load Balancing (SLB) system.

26. The system of claim 22 wherein the processing agent is an Extended Markup Language (XML) system.

27. The system of claim 22 wherein the events include at least one of an event type identification, a Transmission Control protocol (TCP) pointer, a controller handle, a controller length, and a controller prefetch.

28. The system of claim 22 wherein the data stored in the first agent includes a header and a data portion.

29. The system of claim 22 wherein the event system includes an event queue writer and event queue reader for the processing agent.

30. A Transmission Control Protocol (TCP) processing system comprising:
a buffer to store data;
a first agent coupled to the buffer to receive and transmit events;
an event system coupled to the first agent to store the events in at least two event queues;
a first processing agent to process a protocol, the first processing agent having a first and a second connection with the first agent, wherein the first connection transports the data between the first agent and the first processing agent and the second connection transports the events between the first processing agent and the first agent; and
wherein the first agent is configured to monitor the data being transmitted to and received from the processing agent via the first and second connections.

31. The TCP processing system of claim 30 further comprising a second processing agent.

32. The TCP processing system of claim 30 wherein the processing agent is selected from a group comprising a Secure Sockets Layer (SSL) system, a Server Load Balancing (SLB) system, and an Extended Markup Language (XML) system.

33. The TCP processing system of claim 30 wherein the second processing agent is selected a group comprising a Secure Sockets Layer (SSL) system, a Server Load Balancing (SLB) system, and an Extended Markup Language (XML) system.

34. The TCP processing system of claim 30 wherein the protocol is selected from a group comprising a Secure Sockets Layer (SSL) protocol, a Server Load Balancing (SLB) protocol, and an Extended Markup Language (XML) protocol.

35. The TCP processing system of claim 30 wherein the first agent is configured to control the TCP receive window for performing flow control of the processing system.
